(19) United States
(12) Patent Application Publication
(10) Pub. No.: US 2018/0129992 A1
(43) Pub. Date: May 10, 2018

(54) PLANNING LABOR SHIFTS

(71) Applicant: AMAZON TECHNOLOGIES, INC., Reno, NV (US)

(72) Inventors: Julien Samuel Lord, Toronto (CA); Michael Lusthaus, Toronto (CA); Borys Derevyanchenko, Vaughan (CA); Kashif Usmani, Scarborough (CA)

(73) Assignee: AMAZON TECHNOLOGIES, INC., Reno, NV (US)

(21) Appl. No.: 14/106,482

(22) Filed: Dec. 13, 2013

(51) Int. Cl. G06Q 10/06; G06Q 50/28

(52) U.S. Cl. CPC G06Q 10/06311; G06Q 50/28

(57) ABSTRACT

A labor planning application determines a labor plan including an allocation of workers to multiple processing stages during a shift based on estimated work for processing by the respective processing stages during the shift. The labor planning application determines a quantity of workers scheduled for each shift based on a shift schedule. The labor planning application determines the estimated work for each processing stage based on a schedule of deliveries for the location.

### BACKGROUND

Materials handling facilities such as warehouses often implement multiple processing stages to each handle respective tasks in a sequential workflow. Planning and allocating a number of workers to assign to a given processing stage based on an estimate of an amount of work to be completed by a certain time in the future typically involves a manual estimation based on a visual inspection. Manual estimation is prone to human error, and may not take into account scheduled delivery information or future work from processing stages feeding the given processing stage. This creates difficulties in determining how many workers to assign to a given processing stage and results in reactive and costly movements in worker allocation.

### BRIEF DESCRIPTION OF THE DRAWINGS

Embodiments of the present invention will be understood more fully from the detailed description given below and from the accompanying drawings, which, however, should not be taken to limit the present invention to the specific embodiments, but are for explanation and understanding only.

FIG. 1 is a block diagram illustrating networked environment, according to an embodiment.

FIG. 2 is a block diagram illustrating an example representation of a materials handling facility with multiple processing stages and worker allocation, according to an embodiment.

FIG. 3 is a flow diagram illustrating a method for planning a labor shift, according to an embodiment.

FIG. 4 is an example report including a labor plan generated by a client in the networked environment of FIG. 1, according to an embodiment.

FIG. 5 is a block diagram illustrating an exemplary computer system, according to an embodiment.

### DETAILED DESCRIPTION

Materials handling facilities such as warehouses often implement a shift plan to allocate workers for staffing and supporting multiple processing stages to manage the incoming and outgoing flow of items. These processing stages may each be assigned an action in a sequential workflow concluding in the storage of the incoming items and/or the shipment of packed items. For example, a group of processing stages may unload boxes of items from a delivery. These processing stages may then transfer items to processing stages which sort the boxes of items. After sorting, the items may then be transferred to processing stages for unpacking and inventory counts, and then transferred to a processing stage to store the items at designated locations. Additionally, the processing stages may be assigned a particular task in the workflow for a particular classification of items. For example, a processing stage may perform unpacking and inventory counts for large boxes, which had previously been sorted by size in another processing stage.

The number of workers that may be assigned to the various processing stages during a particular shift is established according to a shift schedule. Managers are tasked with assigning the workers during a particular shift to the processing stages in numbers which will prevent bottlenecks in the workflow sequence (e.g., overflow or underflow conditions) and/or the need for a costly labor move (e.g., re-assigning a worker from one process stage to another during a shift). For example, if a first processing stage currently has two hours of work to process during a shift and a second processing stage has fifteen minutes of work to process during that shift, a manager may wish to have more workers from an available pool of workers (e.g., a total number of workers available to work during the shift) to the first processing stage as compared to the number of workers assigned to the second processing stage. This would allow for greater throughput during the shift, reduce the risk of idle workers due to the second processing stage finishing its pending work too quickly, and avoid the need to re-allocate workers during the shift to address the imbalance of work among the various processing stages. These inter-shift transitions result in downtime for the transitioned worker as they move from one processing stage to another.

Reducing the quantity of worker transitions during a shift reduces the amount of time wasted during and after transitions. Managers may monitor the amount of pending work at processing stages to determine how much time it will take the processing stage to process the pending work. Typically, this is accomplished by sending runners to manually inspect the amount of pending work. A manager or another party may then estimate how long it will take to process the pending work using personal experience or other factors. Based on this estimate, the manager may elect to change the allocation of workers among the respective processing stages. However, this reactive movement of labor results in inefficiencies and reduced productivity, particularly in view of the down time resulting from an inter-shift worker reallocation.

A labor planning application determines a labor plan including an allocation of workers to multiple processing stages during a shift based on an estimated amount of work for processing by the respective processing stages during the shift. The labor planning application determines a count of how many workers are available for assignment to the multiple processing stages based on a shift schedule. The labor planning application determines the estimated amount of work for each of the multiple processing stages during a shift based on scheduled delivery information. The labor planning application then determines an estimated amount of time to process the estimated amount of work for each of the multiple processing stages during a particular shift. In an embodiment, the estimated amount of work is determined using a “takt time” which defines an amount of time to process a work unit by a worker for a given action in the sequential workflow. The takt time may also be defined with respect to a type or classification of item to be processed.

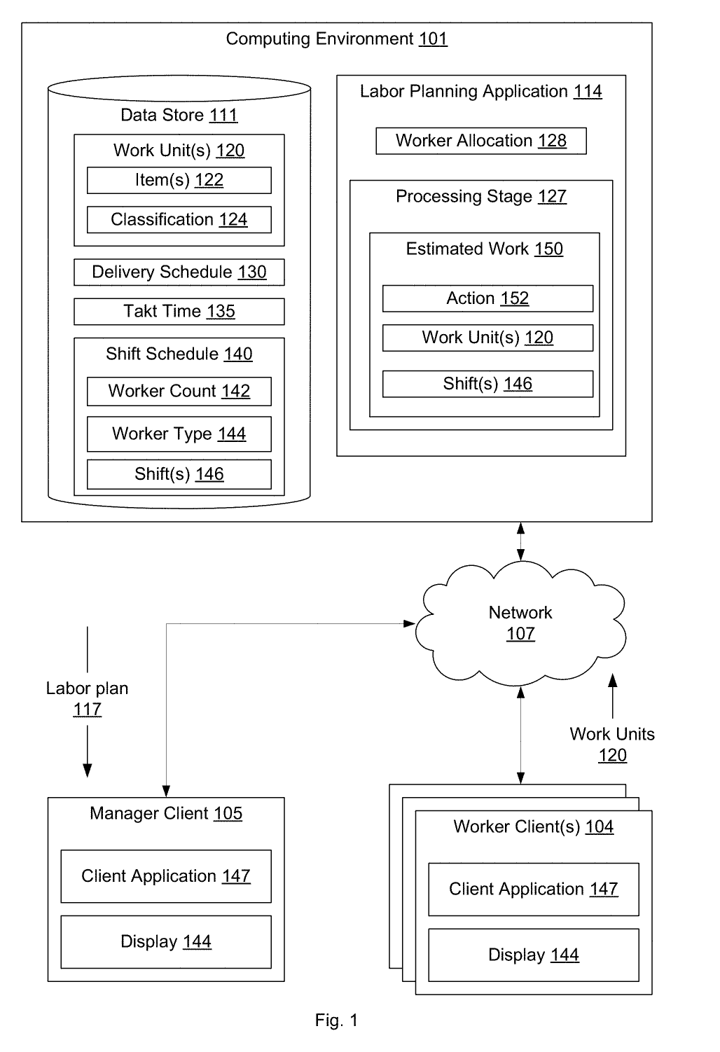

FIG. 1 is a block diagram illustrating a networked environment for planning labor, according to an embodiment. The networked environment 100 includes a computing environment 101, one or more worker clients 104, and a manager client 105, which are in data communication with each other via a network 107. The network 107 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The computing environment 101 may include, for example, a server computer or any other system providing computing capability. Alternatively, the computing environment 101 may employ a plurality of computing devices that may be arranged, for example, in one or more server banks or computer banks or other arrangements. Such computing devices may be located in a single installation or may be distributed among many different geographical locations. For example, the computing environment 101 may include a plurality of computing devices that together may comprise a hosted computing resource, a grid computing resource and/or any other distributed computing arrangement. In some cases, the computing environment 101 may correspond to an elastic computing resource where the allotted capacity of processing, network, storage, or other computing-related resources may vary over time.

Various applications and/or other functionality may be executed in the computing environment 101 according to various implementations. Also, various data may be stored in a data store 111 that is accessible to the computing environment 101. The data store 111 may be representative of a plurality of data stores 111 as can be appreciated. The data stored in the data store 111, for example, is associated with the operation of the various applications and/or functional entities described below.

The components executed on the computing environment 101, for example, can include a labor planning application 114, and other applications, services, processes, systems, engines, or functionality not discussed in detail herein. The labor planning application 114 may be executed to determine a labor plan 117 identifying a worker allocation 128 for each processing stage 127 of multiple processing stages of a location. The worker allocation 128 indicates a quantity of workers allocated to each of the multiple processing stages 127 for each a particular shift 146. The worker allocation 128 represents an estimated quantity of workers for performing an estimated work 150 identified for each processing stage 127 during one or more shifts 146. The estimated work 150 may be based a quantity of work units 120 and a defined action 152 to be performed at a processing stage 127 during a shift 146.

The worker allocation 128 for each of the multiple processing stages 127 during each of the multiple shifts 146 is based on a worker count 142. The worker count 142 indicates a total number of workers available during each of the multiple shifts. The worker count 142 is determined based on a shift schedule 140 (e.g., a schedule identifying which workers are “on” or working during one or more shifts 146). The shift schedule 140 may further include a worker type 144 for the worker count 142 available for each of the one or more shifts 146. The worker type 144 provides a classification or categorization of a particular worker defining one or more actions 152 for which the worker has training, experience, or expertise. The worker type 144 may indicate one or more specialties of a worker and further provide a ranking or scoring indicating a productivity measure for a worker. In an embodiment, the worker type 144 may include a productivity measure for each action 152 performed by a worker. In one embodiment, a worker type 144 may identify an association between a particular worker and a particular action to be performed at a processing stage, such as, for example, an unloading action, an unpacking action, an item check-in action, a box opening action, a sorting action, a stowing action, etc. In an example, the worker type 144 for a particular worker (Worker X) may indicate that Worker X is highly skilled at box opening and sorting actions.

The estimated work 150 includes a quantity of work units 120 estimated for the processing stage 127 during a shift 146. The quantity of work units 120 includes a current work backlog for a processing stage 127 and an estimated quantity of new or inbound work for the processing stage 127 derived from a delivery schedule 130.

In one embodiment, the labor planning application 114 identifies the work backlog by determining a quantity of unprocessed work units 120 or unprocessed items 122 currently assigned to the processing stage 127. In some implementations, the labor planning application 114 may periodically obtain an indication of work units 120 or items 122 awaiting processing at the processing stage 127 (e.g., at the end of a day, the unprocessed work units 120 for each processing stage 127 may be determined in order to determine the estimated work 150 for the following day). For example, a worker client 104 may scan or check in a work unit 120 upon receipt from another processing stage 127. The work backlog may include data indicating that a work unit 120 has been scanned or checked in to a processing stage 127, but the action 152 corresponding to the processing stage 127 has not yet been completed and represents an outstanding work unit 120. The labor planning application 114 may determine a difference between a total quantity of work units 120 and processed work units 120 to determine a quantity of work units 120 or a quantity of items 122 currently awaiting processing (e.g., the work backlog).

In other implementations, a worker client 104 may communicate a total quantity of work units 120 or items 122 awaiting processing at a processing stage 127 in response to a request, at a predefined interval, or responsive to another event. For example, a worker client 104 may take inventory of work units 120 pending processing at defined times or intervals and communicate the quantity of pending work units 120 to the labor planning application 114. In further implementations, a worker client 104 may scan, or otherwise accept as input, a shipping manifest or other inventory of delivered items 122 to determine a quantity of unprocessed work units 120 or items 122. Other approaches may also be used to determine a quantity of unprocessed work units 120 currently assigned to the processing stage 127.

In an embodiment, the estimated work 150 further includes the estimated quantity of new work for the processing stage 127 derived from the delivery schedule 130. The delivery schedule 130 may include an accounting of a quantity of deliveries scheduled for a given period of time (e.g., a listing of the deliveries scheduled for a given day), a size of each of the scheduled deliveries (e.g., a quantity of items 122 estimated for each delivery), and/or a type or category of the items 122 included in each the scheduled deliveries an estimated arrival time for each of the scheduled deliveries. In an embodiment, the delivery schedule 130 may include a manifest for each of the deliveries scheduled for a given period of time, the manifest including delivery information, such as, for example, an identification (e.g., classification, size, type, etc.) of the items included in each scheduled delivery and the estimated arrival time of each scheduled delivery.

In an embodiment, the labor plan 117 includes an indication of the worker allocation 128 identified for performing the estimated work 150 for each of a quantity of processing stages 127 for each of a quantity of different shifts 146 during a period of time (e.g., for each shift 146 during a day, for each shift 146 during a week, for each shift 146 during a month, for each shift 146 during an predetermined number of days).

The processing stage 127 may be a designated area within a location (e.g., a materials handling facility) at which a defined action 152 will be performed for items 122 incoming to the materials handling facility. The action 152 may be one of a sequence of actions defined in a sequential workflow. For example, a sequential workflow for processing incoming items 122 for storage may include an action 152 corresponding to at least one of unloading a shipment, sorting boxes, unpacking boxes and taking inventory, or storing the items 122. Performing an action 152 at a processing stage 127 may produce work units 120 for processing stages 127 corresponding to sequentially later actions 131.

The data stored in the data store 111 includes, for example, work units 120, and potentially other data. Work units 120 define a number or grouping of items 122 for the purposes of determining a processing time 117 using a takt time 135 defined with respect to a particular action 152. For example, work units 120 may include a predefined quantity of items 122. Work units 120 may also include a grouping or organization of items 122 of variable number, such as a box, pallet, or storage bin of items 122, or another grouping. Work units 120 may vary as a function of a respective action 152 to be performed. For example, a sorting action 152 may correspond to a work unit 120 of a box of items 122, while a storing or shelving action 152 may correspond to a work unit 120 of an individual item 122. Work units 120 may also be defined with respect to other criteria or dimensions.

Additionally, work units 120 may have a classification 124 for the purposes of determining a processing time 117. The classification 124 may describe the items 122 included in the work unit 120, such as an item category or subcategory, or another attribute. The classification 124 may also describe an attribute of the work unit 120 as a whole, such as a size of a box, a weight of a box or pallet, special handling instructions, or another attribute.

Takt times 135 define an amount of time to process a work unit 120 via a defined action 152 for a normalized worker. Takt times 135 may also be defined with respect to multiple normalized workers. Additionally, takt times 135 may be defined with respect to a particular classification 124 of work units 120. For example, a takt time 135 for a normalized worker to perform an unpacking action 152 on a large box work unit 120 may be longer than a takt time 135 for the normalized worker to perform an unpacking action 152 on a small box work unit 120. Takt times 135 may vary between workers for the same action 152. For example, a takt time 135 for an experienced worker may be shorter than a less efficient or less experienced worker. Additionally, takt times 135 may vary between actions 152 performed by the same worker. For example, a worker may have a greater takt time 135 for an unpacking action 152 than for a storing action 152. Takt times 135 may also be defined with respect to other dimensions or attributes.

The worker client(s) 104 and the manager client 105 are representative of a plurality of client devices that may be coupled to the network 107. The worker client(s) 104 and the manager client 105 may each comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. In one embodiment, the worker client(s) 104 and the manager client 105 may each include a display 144. The display 144 may include, for example, one or more devices such as liquid crystal displays (LCD), gas plasma-based flat panel displays, organic light emitting diode (OLED) displays, electrophoretic ink (E ink) displays, LCD projectors, or other types of display devices, etc.

The worker client(s) 104 and the manager client 105 may be configured to execute various applications such as a client application 147 and/or other applications. The client application 147 may be executed in a worker client 104 and/or manager client 105, for example, to access network content served up by the computing environment 101 and/or other servers. To this end, the client application 147 may include, for example, a browser, a dedicated application, etc. The worker client(s) 104 and manager client 105 may be configured to execute applications beyond the client application 147 such as, for example, email applications, social networking applications, word processors, spreadsheets, or other applications.

After determining the estimated work 150 for each processing stage 127 during each of the shifts 146, the labor planning application 114 may determine a takt time 135 from which an estimated processing time can be determined. This may include, for example, loading a takt time 135 defined with respect to the action 152 corresponding to the worker processing stage 127. In implementations in which a takt time 135 may be defined with respect to a classification 124, this may also comprise determining a classification 124 of the work units 120 awaiting processing. This may be performed by loading or referencing an inventory indicating a predefined classification 124. In implementations in which the processing stage 127 performs actions 131 on a designated classification 124 of work units 120, this may comprise loading the designated classification 124 corresponding to the processing stage 127.

In other implementations, this may comprise obtaining attributes of the work unit 120 or the included items 122 and applying rules to determine the classification 124. For example, rules may be applied to the dimensions of a box work unit 120 to determine a size classification 124 for the work unit 120 or for the items 122. As another example, an attribute of an item 122 may indicate that the item 122 is fragile. A rule may be applied to this attribute to determine that the work unit 120 should include a fragile classification 124. Rules may also be applied to other attributes of work units 120 or items 122 to determine a classification 124.

In some implementations, a processing stage 127 may have pending work units 120 and new work units 120 identified from the delivery schedule 130 belonging to multiple distinct classifications 124. In such an implementation, the labor planning application 114 may load multiple takt times 135 corresponding to each of the represented classifications 124.

After determining the takt times 135, the labor planning application 114 may determine the worker allocation 128 indicating an estimated quantity of workers to complete the action 152 corresponding to the processing stage 127 on the estimated work 150 for each of the shifts 146. This may include multiplying a quantity of work units 120 of the estimated work 150 for each of the processing stages 127 for each shift 146 by the takt time 135 to determine an estimated processing time for a normalized worker (or a group of normalized workers) per processing stage 127 per shift 146. Having identified the estimated processing time per normalized worker(s) for each processing stage 127 during each shift 146, the labor planning application 114 uses the shift schedule 140 to determine the worker count 142 for each of the shifts 146 (e.g., a quantity of workers available for each of the shifts 146). In an embodiment, the labor planning application 114 may then allocate the worker count 142 available for each shift 146 to the multiple processing stages 127 based on the estimated processing time for each of the processing stages 127.

In an embodiment, the labor planning application 114 determines a total estimated processing time for the multiple processing stages 127 during a shift 146. The labor planning application 114 further determines a percentage of estimated processing time for each individual processing stage 127 of the total estimated processing time during the shift 146. The labor planning application 114 determines a product of the worker count 142 for the shift 146 and the estimated processing time percentage for each processing stage 127 to determine the worker allocations 128 for each of the processing stages 127.

In an example, a daily shift schedule 140 may indicate a worker count 142 of 50 workers for a first shift 146 for a particular location having three processing stages 127 (e.g., a first processing stage 127a, a second processing stage 127b and a third processing stage 127c). The delivery schedule 130 for the location may indicate a delivery of 200 units for processing during the first shift by the first processing stage 127a. The first processing stage 127a may also have 100 units of work backlog from the previous day, resulting in estimated work 150 of 175 work units for the first shift. In this example, the labor planning application 114 may determine a takt time 135 indicating that one normalized worker can perform an unloading action 152 on a single work unit 120 of ten items 122 in two minutes. The estimated work 150 for the first processing stage during the first shift 146 includes 300 units (i.e., 30 work units) and an estimated processing time of 60 minutes. The labor planning application 114 further determines the estimated processing time for the other processing stages at the location during the first shift 146 (i.e., the second processing stage 127b and the third processing stage 127c). For example, the labor planning application 114 determines an estimated processing time of 45 minutes for the second processing stage 127b and an estimated processing time of 75 minutes for the third processing stage 127c.

In view of the estimated processing times for the three processing stages 127a, 127b, and 127c during the first shift 146, the labor planning application 114 determines a total estimated processing time of 180 minutes, with the first processing stage 127a accounting for approximately 33% of the estimated work (i.e., 60 minutes divided by 180 minutes), the second processing stage 127b accounting for approximately 25% of the estimated work, and the third processing stage 127c accounting for approximately 42% of the estimated work.

Based on the above, the labor planning application 114 multiplies the percentage for each processing stage by the worker count 142 for the first shift (e.g., 50 workers) determines a worker allocation 128 of 17 workers for the first processing stage 127a, a worker allocation 128 of 13 workers for the second processing stage 127b, and a worker allocation 128 of 20 workers for the third processing stage 127c. Although in this example, certain values were rounded to a nearest whole number, the labor planning application 114 may be configured to be rounded according to preset or default rules to result in a whole number to allow for a worker to be properly allocated during a shift 146. In an embodiment, a rounding decision may be made by the labor planning application 114 based on a worker type 144 associated with one or more workers in a worker allocation 128. For example, if a worker identified as being highly skilled in an unloading action is part of the worker allocation 128 for the processing stage including the unloading action, the labor planning application 114 may round the worker allocation 128 for that processing stage down to a nearest whole number (e.g., taking into account the worker allocation 128 includes the highly skilled worker). The labor planning application 114 may generate a labor plan 117 including the worker allocations 128 for presentation via display 144 of a manager client 105.

In an embodiment, the labor planning application 114 is configured to further optimize a labor plan 117 for a particular time period. In order to optimize a set of worker allocations 128 associated with a labor plan 117, the labor planning application 114 may determine a “buffer” or estimated work backlog for each processing stage 127 given a particular worker allocation 128. In an embodiment, the labor plan 117 is configured to optimize the various buffers associated with each processing stage 127 such that there are no buffers that are empty (e.g., no processing stage includes a buffer which is zero and includes no backlog) while maintaining an acceptable buffer value for each processing stage 127.

In an embodiment, the labor planning application 114 iteratively adjusts the worker allocations 128 for the various processing stages 127 until the respective buffers for the processing stages 127 are optimized (e.g., there are no buffers that are empty and the values of the respective buffers associated with each processing stage are at an acceptable level).

In an example, the labor planning application 114 may determine a first labor plan for a location including three processing stages 127 (e.g., processing stage A, processing stage B, and processing stage C), the first labor plan including a first worker allocation indicating a worker allocation of five (5) workers for processing stage A, a worker allocation of four (4) workers for processing stage B, and a worker allocation of seven (7) workers for processing stage C. The labor planning application 114 may further determine that the respective buffers for the processing stages given the first worker allocation are twelve (12) work units for processing stage A, nine (9) work units for processing stage B, and zero (0) work units for processing stage C. In this example, in view of a non-optimal value for the buffer associated with processing stage C (e.g., a zero buffer indicating a potential for under-utilization of the workers assigned to that processing stage since a point in time may be reached where there are no work units for the workers to process), the labor planning application 114 may determine a second worker allocation including adjusted worker allocation values for the processing stages.

In view of the adjusted worker allocations, the labor planning application 114 determines the corresponding buffer values for processing stages A, B, and C. The labor planning application 114 may repeatedly adjust the worker allocations and determine the corresponding buffers until the buffer values are optimized. In an embodiment, the labor planning application 114 may compare the buffer values to a buffer threshold value or range in order to determine when optimization has been achieved. In an embodiment, the buffer threshold value may represent an acceptable buffer value or range. For example, the buffer threshold value may be a range from a minimum acceptable buffer value (e.g., a value greater than zero) to a maximum acceptable buffer value (e.g., a value less than or equal to 100 work units).

In an embodiment, as a result of the recursive process described above, the labor planning application 114 may select a labor plan 117 including a set of worker allocations 128 which achieves acceptable buffers values for each of the processing stages 127. Various other rules, constraints, limits, criteria, considerations, etc. may be employed in determining the buffer threshold and optimizing the buffer values.

In an embodiment, the worker type 144 associated with the workers identified on the shift schedule 140 is considered in determining the worker allocation 128. For example, a worker (i.e., Worker ABC) may be associated with a worker type 144 which identifies him/her as highly skilled in an “unloading” action 152. Accordingly, Worker ABC may be capable of unloading a larger quantity of work units 120 as compared to a worker identified as having average skill in unloading. In an embodiment, Worker ABC may be allocated or assigned to a processing stage 127 including the unloading action 152 to increase the efficiency and quality of the worker allocation 128.

In another embodiment, labor planning application 114 can perform a similar determination of the estimated work 150 to be completed during a period of time in the future (i.e., a future time), such as one or more shifts 146 throughout a time period (e.g., the shifts 146 for a particular day, week or month). Labor planning application 114 may receive the future time from one of worker clients 104, from manager client 105 or from some other location (e.g., over network 107). The future time may represent a time in the future (i.e., sometime after the present time), when the estimated work 150 is of interest. Labor planning application 114 can thus determine an estimated work 150 and an estimated processing time to be completed at one or more processing stages 127 during by the future time (e.g., the one or more shifts 146). This may include multiplying a rate at which work units 120 or items 122 are processed at the processing stage 127 (based on the takt time 135) by the amount of time remaining until the future time is reached and dividing the product by the worker allocation 128 assigned to the processing stage 127 in the time until the future time (e.g., the workers allocated to the processing stage 127 in the one or shifts 146 before the shift 146 of interest at the future time). In one embodiment, the estimated work 150 to be completed at processing stage 127 by the future time may have an effect on the estimated work 150 at a downstream processing stage 127 in the sequence.

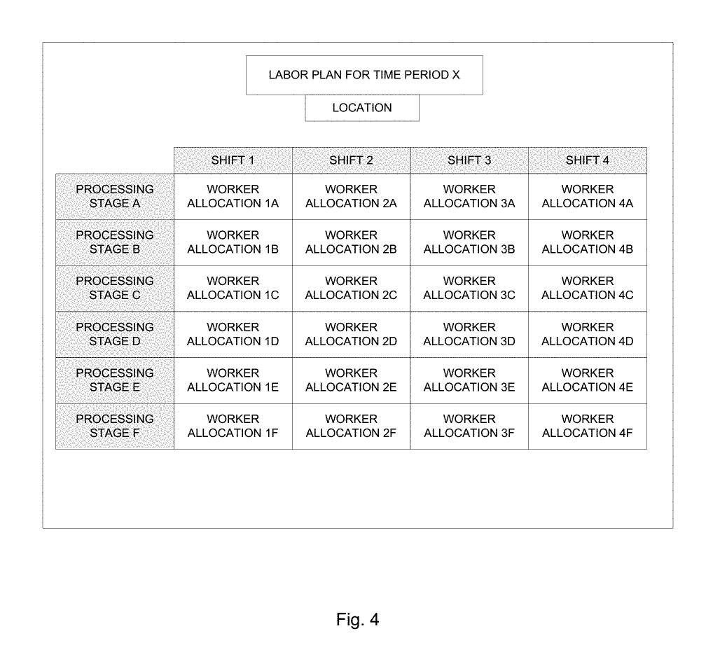

The labor planning application 114 communicates the labor plan 117 to a manager client 105. This may be performed by encoding a report including the labor plan 117 for rendering by a client application 147 executed in the manager client 105. The report may be embodied as a network page, document, push notification, email, or other format as can be appreciated. The report may include multiple worker allocations 128 for multiple processing stages 127 during multiple shifts 146, as shown in the example in FIG. 4. The report may also include other data as well.

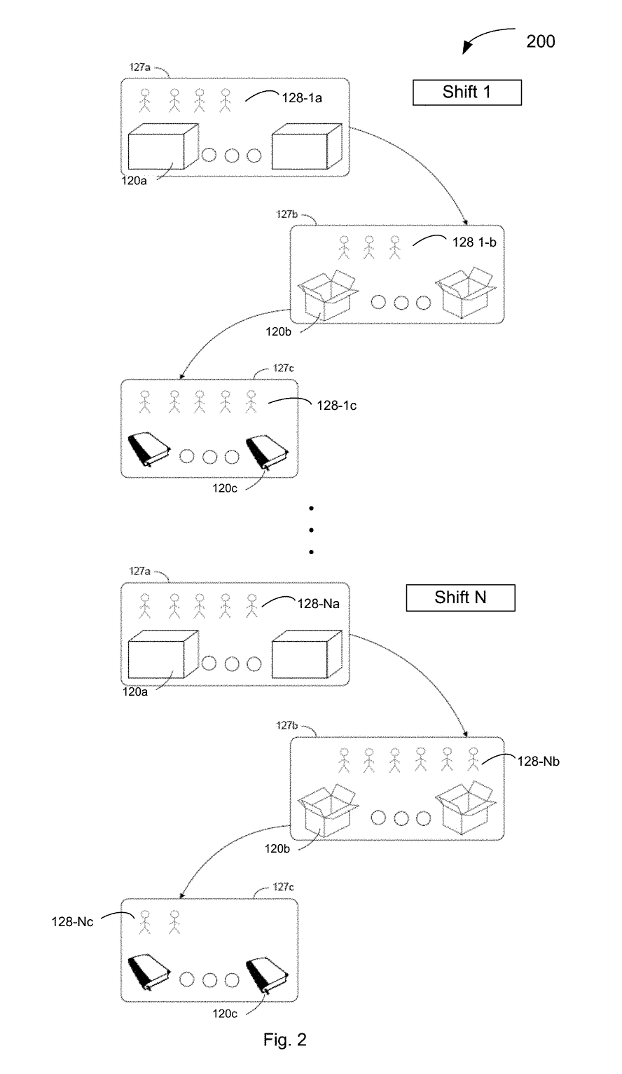

FIG. 2 is a block diagram illustrating an example representation of a materials handling facility with multiple processing stages, according to an embodiment. The materials handling facility 200 may implement a sequential workflow using processing stages 127 according to various implementations of the present disclosure. The materials handling facility 200 may include, for example, a warehouse, storage unit, fulfillment center, or other facility. Processing stage 127a is representative of a processing stage 127 performing a sorting action 152, where incoming boxes are sorted according to size or other attributes. The labor planning application determines the estimated work 150 for the processing stage 127a includes work units 120a each corresponding to a single box of items 122 to be delivered to the materials handling facility 200 according to a delivery schedule 130 and/or work backlog (e.g., existing work units 120 previously assigned to processing stage 127a) for shift 1. Similarly, the labor planning application determines the estimated work 150 for the processing stage 127b (e.g., a processing stage wherein the boxes are opened and an action 152 is performed to take inventory of the items 122) includes work units 120b each corresponding to a single box of items 122 to be delivered to the materials handling facility 200 according to a delivery schedule 130 and/or work backlog (e.g., existing work units 120 previously assigned to processing stage 127b) for shift 1. The labor planning application also determines the estimated work 150 for the processing stage 127c (e.g., a processing stage wherein the inventoried items 122 are stored on shelves) includes work units 120c each corresponding to a single item 122 to be delivered to the materials handling facility 200 according to a delivery schedule 130 and/or work backlog (e.g., existing work units 120 previously assigned to processing stage 127c) for shift 1.

In an embodiment, the process described above with respect to shift 1 may be repeated for any quantity of shifts 146 during a period of time for which the labor plan 117 is desired. In the example shown in FIG. 2, the labor plan 117 is generated for a period of one week including N number of shifts.

Based on a worker count 142 for each shift 146 (e.g., shift 1, shift 2, . . . and shift N) as determined from a shift schedule 140, the labor planning application 114 determines a worker allocation 128 for each of the processing stages 127 during each of the shifts 146. As shown in FIG. 2, the labor planning application 114 determines a worker allocation 128-1a of four workers for processing stage 127a during shift 1, a worker allocation 128-1b of three workers for processing stage 127b during shift 1, and a worker allocation 128-1c of five workers for processing stage 127c during shift 1. In addition, labor planning application 114 determines a worker allocation 128 for each of the N shifts 146 during the desired period of time. In the example shown in FIG. 2, the labor planning application 114 determines a worker allocation 128-Na of five workers for processing stage 127a during shift N, a worker allocation 128-Nb of six workers for processing stage 127b during shift N, and a worker allocation 128-Nc of two workers for processing stage 127c during shift N.

It is understood that the example materials handling facility 200 only provides an example implementation of a sequential workflow using processing stages 127a-c. Although the example materials handling facility 200 depicts the output of processing stages 127a/b being transferred to a single processing stage 127b/c, it is understood that in some implementations processing stages 127 may transfer work units 120 or items 122 to multiple other processing stages 127. Additionally, although the example materials handling facility 200 depicts processing stages 127b/c receiving work units 120 or items 122 from a single other processing stage 127a/b, it is understood that in some implementations processing stages 127 may receive work units 120 or items 122 from multiple other processing stages 127.

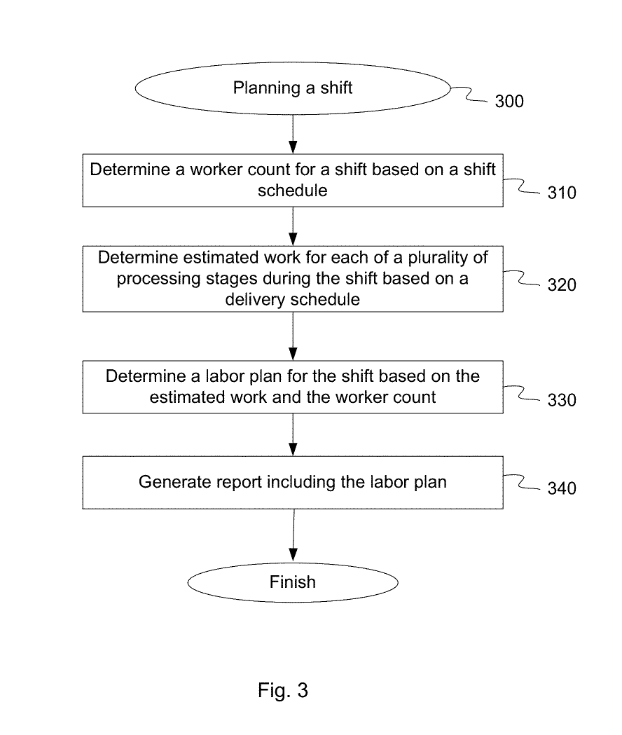

FIG. 3 is a flow diagram illustrating a method for planning a labor shift for a location including multiple processing stages, according to an embodiment. The method 300 may be performed by processing logic that comprises hardware (e.g., circuitry, dedicated logic, programmable logic, microcode, etc.), software (e.g., instructions run on a processor to perform hardware simulation), firmware, or a combination thereof. The processing logic is configured to predict the future downstream workload based on an estimate of work completed at an upstream processing stage. In one embodiment, method 300 may be performed by labor planning application 114, as shown in FIG. 1.

Referring to FIG. 3, at block 310, method 300 determines a worker count for a shift based on a shift schedule for the location. In one embodiment, labor planning application 114 may receive the shift schedule from one of worker client(s) 104, manager client 105, or from some other source. The worker count may represent a total quantity of workers scheduled to work during the one or more shifts. The shift schedule may also include a worker type associated with one or more of the workers.

At block 320, method 300 determines the estimated work for each of the multiple processing stages for the location during the shift. In one embodiment, labor planning application 114 determines the estimated work for each processing stage based on a delivery schedule. In one embodiment, the delivery schedule identifies one or more scheduled deliveries which impact a quantity of work units to be processed during the identified shift. In one embodiment, labor planning application 114 determines the estimated work based on both the delivery schedule and a backlog of work assigned to each of the multiple processing stages during the shift. In an embodiment, the estimated work may be based on the quantity of work units 120, the takt time 135 or other factors.

At block 330, method 300 determines a labor plan for the shift based on the estimated work and the worker count. In an embodiment, the labor plan includes a worker allocation (e.g., a quantity of workers of the total worker count) assigned or allocated to each of the multiple processing stages during the shift. In one embodiment, worker allocation for each processing stage represents a percentage of the total worker count for the shift corresponding to a percentage of estimated work of the total estimated work for the shift for that processing stage. In one embodiment, the worker allocation is determined based on other factors derived from the shift schedule, such as, for example, scheduled break times or other scheduled transition times (e.g., start of a shift, end of a shift, etc.). In one embodiment, labor planning application 114 stores the determined worker allocation in data store 111.

At block 340, method 300 generates a report including the labor plan. In one embodiment, the report includes information identifying a worker allocation for each processing stage for each shift during an identified time period.

In an embodiment, the method 300 may be performed at any time and frequency during a given time period based on a “current” state of the various data maintained in the data store 111 (e.g., the shift schedule 140, estimated work 150, delivery schedule 130, etc.) considered by the labor planning application 114 in determining a labor plan. For example, the labor planning application 114 may determine a labor plan at any time during a day or shift based on the dynamically changing and updated data maintained in the data store 111. In an embodiment, the labor planning application 114 may use the updated data in the data store 111 (e.g., the current data at any particular point in time) to determine a labor plan in real-time, such that a manager may make labor moves or other reactive decisions in light of the “updated” or current labor plan. In this regard, the labor planning application 114 may repeatedly determine a labor plan based on the then current data to provide a manager with substantially real-time labor planning information.

FIG. 4 illustrates an exemplary report including an example labor plan generated according to embodiments of the present disclosure. In FIG. 4, the example report includes a labor plan for a period of time (i.e., Time Period X) for a particular location (e.g., a particular processing facility). The exemplary location includes processing stages A-F and operates according to a four shift schedule (i.e., shift 1, shift 2, shift 3 and shift 4).

As shown in FIG. 4, the labor planning application determines a worker allocation for each processing stage for each shift during Time Period X. For example, the labor plan indicates a worker allocation 1A for processing stage A during shift 1, a worker allocation 2A for processing stage A during shift 2, a worker allocation 3A for processing stage A during shift 3, and a worker allocation 4A for processing stage A during shift 4.

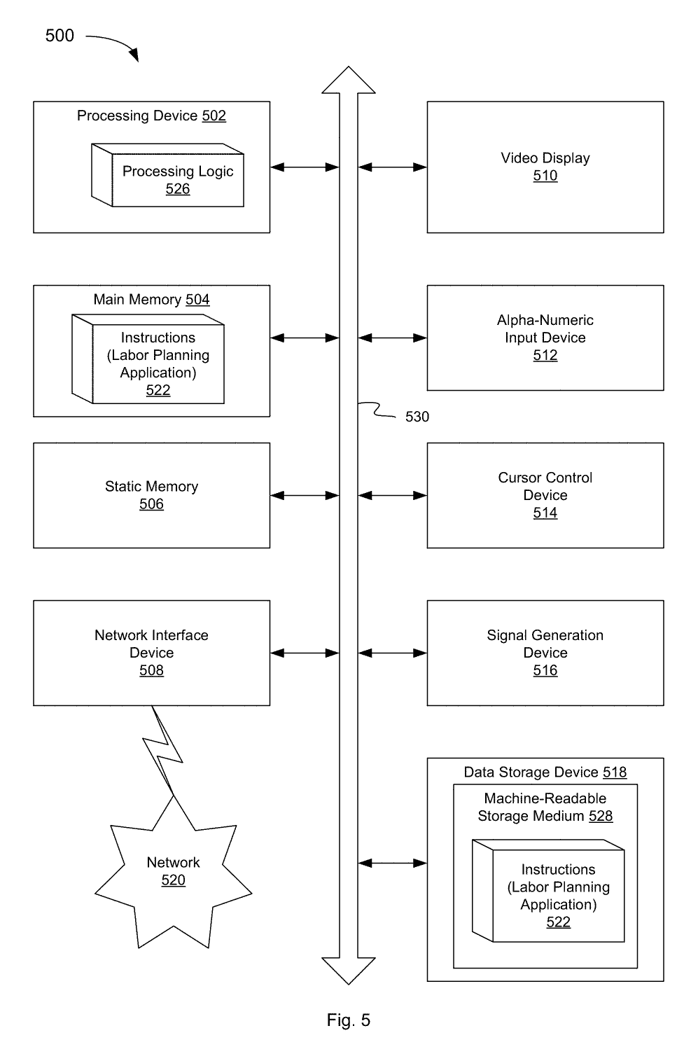

FIG. 5 illustrates a diagrammatic representation of a machine in the exemplary form of a computer system 500 within which a set of instructions, for causing the machine to perform any one or more of the methodologies discussed herein, may be executed. The system 500 may be in the form of a computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 500 may represent computing environment 101 of FIG. 1.

The exemplary computer system 500 includes a processing device (processor) 502, a main memory 504 (e.g., read-only memory (ROM), flash memory, dynamic random access memory (DRAM) such as synchronous DRAM (SDRAM)), a static memory 506 (e.g., flash memory, static random access memory (SRAM)), and a data storage device 518, which communicate with each other via a bus 530.

Processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute the content logic 316 and the transition logic 317 for performing the operations and steps discussed herein.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a computer-readable medium 528 on which is stored one or more sets of instructions 522 (e.g., instructions of the labor planning application 114) embodying any one or more of the methodologies or functions described herein. The instructions 522 may also reside, completely or at least partially, within the main memory 504 and/or within processing logic 526 of the processing device 502 during execution thereof by the computer system 500, the main memory 504 and the processing device 502 also constituting computer-readable media. The instructions may further be transmitted or received over a network 520 via the network interface device 508.

While the computer-readable storage medium 528 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

The preceding description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

In the above description, numerous details are set forth. It will be apparent, however, to one of ordinary skill in the art having the benefit of this disclosure, that embodiments of the invention may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining”, “generating”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A method comprising:
determining, by a processing device, a first worker count for a first shift during a time period, wherein the first shift is identified on a shift schedule for a materials handling facility comprising a first processing stage;
analyzing a delivery schedule comprising information identifying a plurality of items scheduled to arrive at the materials handling facility during the time period, wherein the information identifying the plurality of items comprises a quantity and a classification of the plurality of items;
determining, by the processing device, first estimated work for the first processing stage during the first shift by calculating a quantity of work units as a function of the quantity and the classification of the plurality of items identified on the delivery schedule;
determining, by the processing device, a first worker allocation for the first processing stage during the first shift, wherein the first worker allocation represents a quantity of workers of the worker count to perform the first estimated work;
determining, by the processing device, a labor plan comprising the first worker allocation for the first processing stage during the first shift; and
generating, by the processing device, a report comprising the labor plan.

2. The method of claim 1, wherein the first estimated work further comprises a backlog of items allocated to the first processing stage and identified as unprocessed.

3. The method of claim 2, further comprising:
determining, by the processing device, a first estimated processing time for the first estimated work for the first processing stage during the first shift;
determining, by the processing device, a total processing time comprising a sum of the first estimated processing time and a second estimated processing time for a second processing stage during the first shift; and
determining, by the processing device, a percentage of the first estimated processing time over the total processing time, wherein the first worker allocation for the first processing stage during the first shift comprises a first quantity of workers corresponding to the percentage of the worker count.

4. The method of claim 3, wherein the first estimated processing time for the first estimated work for the first shift is calculated using a first takt time defining a first amount of time it takes a worker to process a work unit corresponding to a first item of a first type in the first processing stage.

5. The method of claim 1, wherein determining the first worker allocation for the first processing stage during the first shift comprises calculating a productivity measure for a first worker identified on the shift schedule.

6. The method of claim 1, further comprising:
determining, by the processing device, a second labor plan comprising a second worker allocation for the first processing stage at a different time during the time period by analyzing at least one of a second delivery schedule, second estimated work for the first processing stage, or a second shift schedule.

7. The method of claim 1, further comprising:
determining, by the processing device, a buffer value for the first processing stage by analyzing the labor plan; and
determining, by the processing device, the buffer value for the first processing stage is less than a maximum acceptable buffer value.

8. A system comprising:
a memory to store instructions; and
a processing device, operatively coupled with the memory, to execute the instructions to:
determine a first worker count for a first shift identified on a shift schedule for a location comprising a first processing stage;
analyze a delivery schedule comprising information identifying a plurality of items to be processed by first processing stage during the first shift, wherein the information identifying the plurality of items comprises a quantity and a classification corresponding to each of the plurality of items;
determine first estimated work for the first processing stage during the first shift by calculating a quantity of work units as a function of the quantity and the classification corresponding to each of the plurality of items identified on the delivery schedule;
determine a first worker allocation for the first processing stage during the first shift, wherein the first worker allocation represents a quantity of workers of the first worker count to perform the first estimated work; and
determine a labor plan comprising the first worker allocation for the first processing stage during the first shift.

9. The system of claim 8, wherein the first processing stage corresponds to at least one action of a plurality of actions performed in a workflow of the location.

10. The system of claim 8, wherein the first worker allocation identifies a particular worker corresponding to a worker type associated with the particular worker.

11. The system of claim 8, the processing device to:
determine a takt time defined with respect to the classification of a first item, a normalized worker, and a first action corresponding to the first estimated work for the first processing stage.

12. The system of claim 11, the processing device to determine the first estimated work using the takt time and the quantity of the items.

13. The system of claim 11, wherein the takt time comprises a quantity of time for the normalized worker to process one item of the quantity of the plurality of items in the first processing stage.

14. The system of claim 8, wherein the first estimated work comprises a second quantity of items previously allocated for processing by the first processing stage.

15. The system of claim 8, wherein a sum of the first worker allocation and one or more additional worker allocations equals the worker count for the first shift.

16. The system of claim 8, the processing device to:
determine a buffer value for the first processing stage by analyzing the labor plan; and
determine the buffer value for the first processing stage is less than a maximum acceptable buffer value.

17. The system of claim 16, the processing device to:
determine a second buffer value for the first processing stage, and
determine the second buffer value for the first processing stage is less than the maximum acceptable buffer value.

18-23. (canceled)
